(19) United States
(12) Patent Application Publication
(10) Pub. No.: US 2026/0099956 A1
(43) Pub. Date: Apr. 9, 2026

(54) IMAGE PROCESSING APPARATUS, IMAGE PROCESSING METHOD, AND PROGRAM

(71) Applicant: Sony Interactive Entertainment Inc., Tokyo (JP)

(72) Inventors: Tomokazu Kake, Tokyo (JP); Akio Ohba, Kanagawa (JP); Daichi Ono, Kanagawa (JP)

(73) Assignee: Sony Interactive Entertainment Inc., Tokyo (JP)

(21) Appl. No.: 19/115,555

(22) PCT Filed: Nov. 1, 2022
(86) PCT No.: PCT/JP2022/040898

§ 371 Date: Mar. 26, 2025

(51) Int. Cl. G06T 11/00; G06T 13/00; G06V 10/25; G06V 10/26; G06V 20/40

(52) U.S. Cl. CPC G06T 11/00; G06T 13/00; G06V 10/25; G06V 10/26; G06V 20/41

(57) ABSTRACT

An image processing apparatus creates at least one digest image by extracting, from each of a plurality of frame pictures constituting a video to be verified, partial pictures of positions different from each other, and verifies the contents of the video on the basis of the digest image.

### TECHNICAL FIELD

The present invention relates to an image processing apparatus, an image processing method, and a program for analyzing videos

### BACKGROUND ART

When testing a program of a video game or the like, whether the contents of a video displayed as the processing result are as expected and whether a trouble such as an image disturbance is generated are verified in some cases. As a result of verification of the contents of the video, a trouble or an unexpected display in the video can be found.

### SUMMARY

### Technical Problem

Visual verification of a video with manpower requires much labor, and there is also a concern that the accuracy is insufficient. On the other hand, if a video is verified by conducting an analysis process of each of frame pictures constituting the video, the computation amount of an image processing apparatus is increased in general. This is likely to require much time.

The present invention has been made in view of the above circumstances, and an object thereof is to provide an image processing apparatus, an image processing method, and a program by which verification of the contents of a video can be conducted by a relatively simple process.

### Solution to Problem

An image processing apparatus according to one aspect of the present invention includes one or more processors, in which the one or more processors creates at least one digest image by extracting, from each of a plurality of frame pictures constituting a video to be verified, partial pictures of positions different from each other, and verifies contents of the video on the basis of the digest image.

An image processing method according to one aspect of the present invention includes creating at least one digest image by extracting, from each of a plurality of frame pictures constituting a video to be verified, partial pictures of positions different from each other, and verifying contents of the video on the basis of the digest image.

A program according to one aspect of the present invention causes a computer to execute processes of creating at least one digest image by extracting, from each of a plurality of frame pictures constituting a video to be verified, partial pictures of positions different from each other, and verifying the contents of the video on the basis of the digest image. The program may be provided in a state of being stored in a computer readable and non-temporal information recording medium.

### BRIEF DESCRIPTION OF DRAWINGS

FIG. 1 is a configuration block diagram depicting a configuration of an image processing apparatus according to an embodiment of the present invention.

FIG. 2 is a functional block diagram of the image processing apparatus according to the embodiment of the present invention.

FIG. 3 is a diagram depicting one example of a configuration of a digest image.

FIG. 4 is a diagram depicting an example of a digest image created on the basis of a target video including a scene transition.

FIG. 5 is a diagram depicting an example of a digest image created on the basis of a target video including an abnormal display.

FIG. 6 is a diagram depicting an example of a digest image created on the basis of a target video including an object that moves with time.

FIG. 7 is a diagram depicting another example of a digest image created on the basis of a target video including an abnormal display.

### DESCRIPTION OF EMBODIMENT

Hereinafter, an embodiment of the present invention will be explained in detail with reference to the drawings.

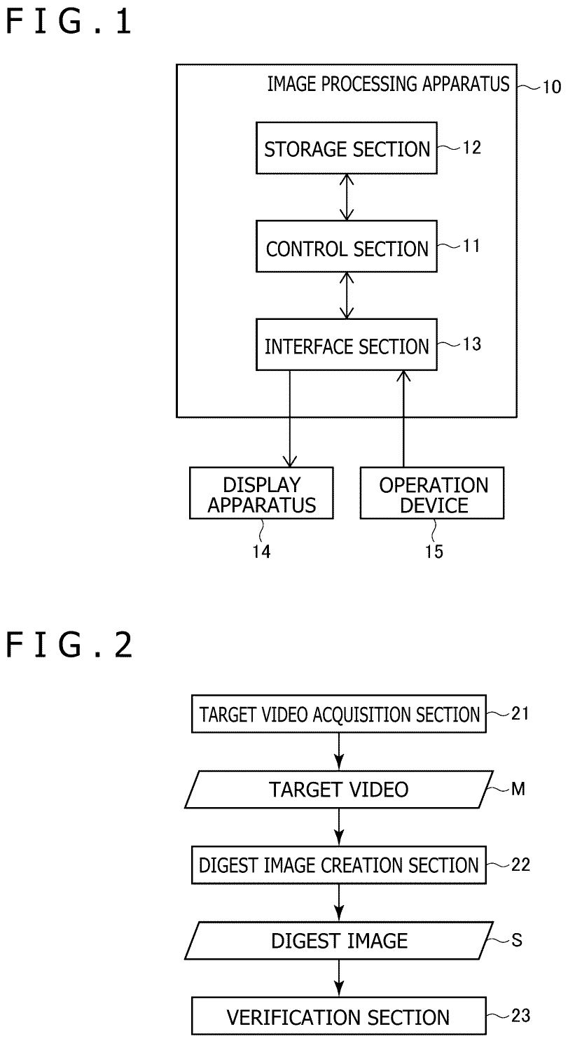

FIG. 1 is a configuration block diagram depicting a configuration of an image processing apparatus 10 according to one embodiment of the present invention. The image processing apparatus 10 is a personal computer or a server computer, for example. As depicted in FIG. 1, the image processing apparatus 10 includes a control section 11, a storage section 12, and an interface section 13. In addition, the image processing apparatus 10 is connected with a display apparatus 14 and an operation device 15.

The control section 11 includes at least one processor such as a central processing unit (CPU) and is configured to execute a variety of information processes by executing a program stored in the storage section 12. It is to be noted that specific examples of the processes that are executed by the control section 11 in the present embodiment will be explained later. The storage section 12 includes at least one memory device such as a random access memory (RAM). A program to be executed by the control section 11 and data to be processed in the program are stored in the storage section 12.

The interface section 13 is an interface for data communication with the display apparatus 14 and the operation device 15. The image processing apparatus 10 is connected with each of the display apparatus 14 and the operation device 15 via the interface section 13 wired or wirelessly. Specifically, it is assumed that the interface section 13 includes a multimedia interface for transmitting a video signal supplied from the image processing apparatus 10 to the display apparatus 14. Further, the interface section 13 includes a data communication interface for receiving a signal indicating operation contents performed by a user through the operation device 15.

The display apparatus 14 displays, on a screen, a video corresponding to a video signal supplied from the image processing apparatus 10. The operation device 15 is a keyboard or a mouse, for example. The operation device 15 receives operation input contents from a user. The operation device 15 is connected with the image processing apparatus 10 wired or wirelessly and transmits an operation signal indicating the operation input contents received from the user to the image processing apparatus 10.

Hereinafter, functions that are implemented by the image processing apparatus 10 will be explained with reference to a functional block diagram in FIG. 2. As depicted in FIG. 2, the image processing apparatus 10 functionally includes a target video acquisition section 21, a digest image creation section 22, and a verification section 23. These functions are implemented when the control section 11 works in accordance with one or more programs stored in the storage section 12. The programs may be provided to the image processing apparatus 10 via a communication network such as the internet or may be provided by being stored in a computer readable information storage medium such as an optical disk.

The target video acquisition section 21 acquires a video (hereinafter, referred to as a target video M) to be verified by the image processing apparatus 10 according to the present embodiment. The target video acquisition section 21 may acquire, as the target video M, a video previously created by another image creating apparatus and recorded in an information recording medium, or may acquire, as the target video M, a video rendered by the image processing apparatus 10 itself and displayed on the screen of the display apparatus 14.

The digest image creation section 22 creates at least one digest image S expressing the contents of the target video M on the basis of the target video M acquired by the target video acquisition section 21. The digest image S is a still picture created on the basis of a plurality of frame pictures F constituting the target video M. Furthermore, it is assumed that the digest image S has the same size and the same shape as the frame pictures F.

Specifically, the digest image creation section 22 creates the digest image S by extracting a partial picture P from each of the frame pictures F constituting the target video M, and then arranging the extracted partial pictures P. It is assumed that the partial pictures P extracted from the respective frame picture are pictures of different regions, and the positions of the extracted partial pictures P in the digest image S correspond to the respective positions in the original frame pictures F. Accordingly, the digest image S is one still picture that represents a digest of the target video M that is displayed for a certain time period.

In the following specific example, it is assumed that the digest image creation section 22 creates the digest image S by extracting, from each of the frame pictures F, one row of pixels arranged in a horizontal direction as a partial picture P. In a case where the target video M is a 60-fps video and the vertical length of the frame pictures F is 720 pixels, the number of the frame pictures F constituting the target video M for a reproduction time of 12 seconds is 720 (=60 fps×12 seconds), which coincides with the value of the vertical length of each frame picture F (i.e., the number of the partial pictures constituting the digest image S). Hereinafter, the frame pictures F are denoted by F(1), F(2), F(3), . . . F(n), . . . F(720) in order from the top. In addition, the partial picture P extracted from the frame picture F(n) is denoted by P(n).

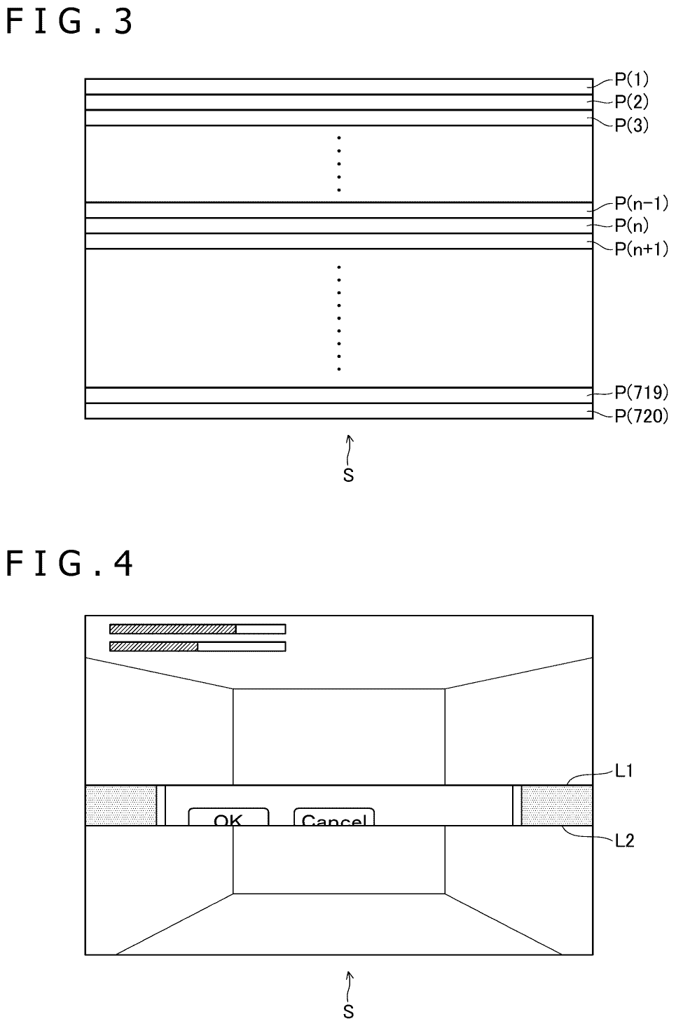

The digest image creation section 22 extracts, as the partial picture P(1), a row of pixels arranged in the horizontal direction on the top of the frame picture F(1). The partial picture P(1) is set as the top pixel row in the digest image S. Further, the second pixel row from the top in the frame picture F(2) is extracted as the partial picture P(2), and is set as the second pixel row from the top in the digest image S. Similarly, the n-th pixel row from the top in the frame picture F(n) is extracted as the partial picture P(n), and is set as the n-th pixel row from the top in the digest image S. This process is repeated for 720 frame pictures F, whereby the digest image S having a vertical length of 720 pixels is created. FIG. 3 schematically depicts the configuration of the digest image S.

The digest image S includes the partial pictures P respectively extracted from 720 frame pictures F and having the same size. The partial pictures P are extracted from different positions in the respective original frame pictures F, and are set, in the digest image S, at the same positions as the positions in the original frame pictures F. Moreover, the partial pictures P are arranged in the same order as the display order of the original frame pictures F. Accordingly, in the digest image S, the partial pictures P extracted from temporarily adjacent frame pictures F are arranged to be spatially adjacent to each other. The digest image S is an image similar to what is called a slit-scan image. In the digest image S, temporal change contents in the target video M are reflected.

By using the digest image S created by the digest image creation section 22, the verification section 23 verifies the contents of the target video M. It is assumed that this verification involves detecting an abnormal display (i.e., a trouble in the displayed contents) included in the target video M. By analyzing the digest image S, the verification section 23 can detect a possibility that the target video M includes an abnormal display. An abnormal display herein refers to an unnatural display such as an image disturbance or a screen transition at an unexpected timing, which is different from a normal display originally intended.

Hereinafter, some specific examples of verification processes to be executed by the verification section 23 will be explained.

First, a process of verifying the presence/absence of flicker or a scene transition which occurs during a reproduction time of the target video M will be explained as a first example. Flicker herein refers to a phenomenon that a different display or an unexpected display appears in a relatively wide range of the screen, or, for example, a phenomenon that the entire screen blinks or the display instantaneously turns into a different color in a wide range of the screen when the target video M is being displayed. It is to be noted that specific examples will be given below in which it is assumed that the target video M includes a scene transition of switching the overall displayed contents on the screen to different ones, and a timing of occurrence of this scene transition is previously held in the image processing apparatus 10.

It is assumed that each partial picture P is a pixel row extending in a horizontal direction, as previously explained. Therefore, a boundary between the adjacent partial pictures P is a straight line extending in a horizontal direction. In this example, it is highly likely that a partial picture P extracted from a frame picture F immediately before a timing of occurrence of a scene transition is significantly different in pixel values (e.g., brightness value and density value) from a partial picture P extracted from a frame picture F immediately after the scene transition. For this reason, in the digest image S, a straight edge appears in a position where these partial pictures P are adjacent to each other. In this manner, a line along a boundary between the adjacent partial pictures P is detected from the digest image S. Accordingly, the verification section 23 can identify a timing, during the target video M, at which the entire display content on the screen suddenly changes due to a scene transition or the like.

FIG. 4 depicts one example of the digest image S. FIG. 4 depicts the digest image S created on the basis of the target video M that is displayed during execution of a game program, and depicts an example in which, during display of the target video M, a menu screen having a black background is displayed at a time t1, displaying the menu screen ends, and the original play screen is displayed at a time t2. In positions corresponding to the scene transitions at the time t1 and the time t2, boundaries L1 and L2 appear in the digest image S. Pixel rows above the boundary L1 are extracted from the frame pictures F that are displayed prior to the time t1. Pixel rows between the boundaries L1 and L2 are extracted from the frame pictures F that are displayed from the time t1 to the time t2 (that is, which presents the menu screen). Pixel rows below the boundary L2 are extracted from the frame pictures F that are displayed subsequent to the time t2. It is to be noted that, for convenience of explanation, it is assumed that the displayed contents of the target video M do not change except at timings of the scene transitions at times t1 and t2 in this depicted example. Actually, since the displayed contents vary with time irrespective of a timing of the scene transitions, discontinuous changes over a boundary between the partial pictures P appear in the digest image S. However, as long as there is no drastic change in the overall displayed contents on the screen, the boundaries L1 and L2 as clear as those in FIG. 4 are not expected to appear in any other positions.

By executing image processing on the digest image S, the verification section 23 detects a straight line extending in a horizontal direction (that is, in parallel with a boundary between the partial pictures P). Detection of a straight line that appears in the image is realized by a known image processing technology such as Hough transformation or edge detection. It is to be noted that, in order to detect such a straight line, the verification section 23 may first execute preprocessing such as binarization of the digest image S before executing the image processing such as edge detection. Alternatively, the image processing may be executed using any technique such as deep learning.

A line extending along a boundary between the partial pictures P (here, a straight line extending in a horizontal direction) is assumed to correspond to a scene transition in the target video M. Therefore, if the number of such straight lines and the positions thereof are identified, whether or not scene transitions have normally occurred can be verified.

Specifically, the verification section 23 verifies whether the number and the positions of the detected straight lines are deviated from the expected number and the expected timings of scene transitions. If more horizontal straight lines are detected than expected, there is a possibility that a display abnormal such as flicker occurs in the target video M at any one of the timings corresponding to the positions of the detected straight lines. In addition, in a case where a horizontal straight line is detected in a position deviated from an expected position, there is a possibility that the timing of the scene transition in the target video M is deviated from the expected timing. As a result of this verification of the number of straight lines and the positions thereof, a display abnormality in the target video M can be detected.

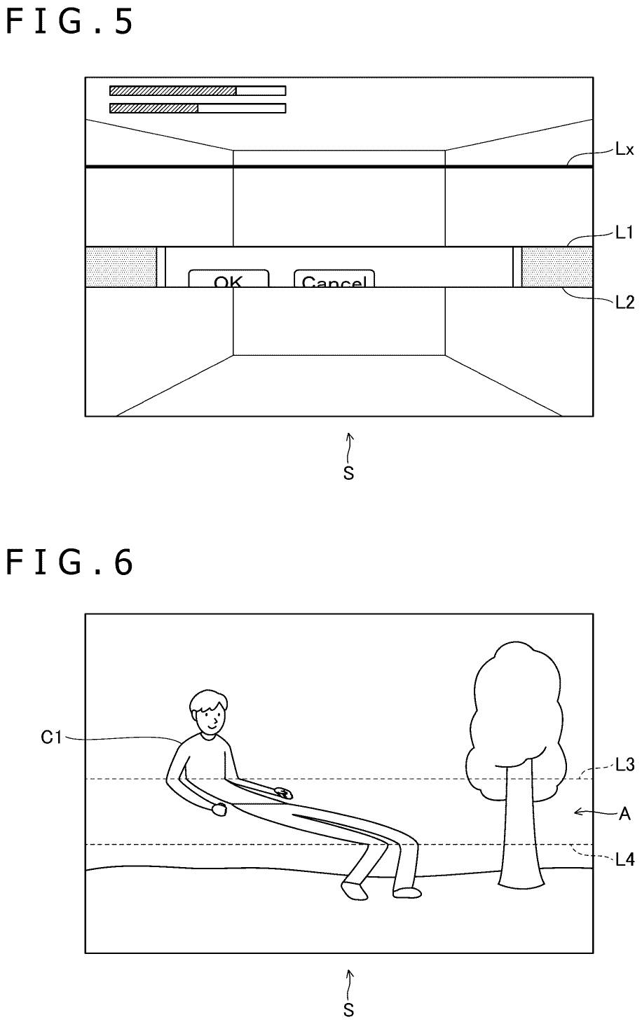

FIG. 5 depicts one example of the digest image S in a case where flicker occurs in the target video M. Compared to the example depicted in FIG. 4, the example depicted in FIG. 5 indicates a horizontal line Lx included in the digest image S, in addition to the boundaries L1 and L2 corresponding to the timings of the scene transitions. There is a possibility that flicker, which is an instantaneous blackout of the entire screen when the target video M is displayed, occurs at a timing corresponding to the horizontal line Lx.

Next, as a second example of the verification process, an example of detecting a lagging display in the target video M will be explained. Lagging herein refers to a phenomenon that the contents displayed on the screen do not smoothly change as expected, due to frame dropping or the like.

In a case where an object that moves with time is included in the target video M, it is assumed that the movement path of the object is represented by a line extending in a direction intersecting a horizontal straight line (i.e., a line extending along a boundary between the partial pictures P) in the digest image S. FIG. 6 depicts one example of the digest image S including such a movement path of the object. In the example depicted in this drawing, when the target video M is being displayed, a character object C1 is at rest on the left side of the screen until a time t3, moves to the right side of the screen during a time period from the time t3 to a time t4, and then, is at rest again. It is to be noted that, for convenience of explanation, it is assumed that objects such as the background etc. excluding the character object C1 remain unchanged when the target video M is being displayed. In addition, it is assumed that the position of the character object C1 changes with time but the external appearance and the shape of the character object C1 do not change when the target video M is being displayed. In this drawing, a boundary L3 between the partial pictures P corresponding to the time t3 and a boundary L4 between the partial pictures P corresponding to the time t3 are indicated respectively by broken lines. A region A between the boundaries L3 and L4 is formed of the partial pictures P extracted from the frame pictures F displayed in the time period from the time t3 to the time t4. The character object C1 moves rightward with time in the time period from the time t3 to the time t4 so that the character object C1 is obliquely deformed in the region A, which reflects this movement. That is, in the digest image S, an object in the target video M appears in a deformed shape along the movement direction.

Here, in a case where lagging occurs in the target video M being displayed, a movement process of an object included in the video is not smoothly (continuously) displayed, and a discontinuous change is generated. When a display abnormality of this type occurs, a line representing the outline of the object may be, in the digest image S, not a continuously deformed line but a line that is broken or is suddenly bent to a different direction at a position between the partial pictures P corresponding to the timing of occurrence of the lagging. To this end, the verification section 23 detects a line that intersects a boundary between the partial pictures P and is broken or unnaturally bent. Accordingly, the verification section 23 can detect whether there is a possibility that lagging occurs in the target video M. It is to be noted that the verification section 23 can detect such a discontinuous line by a method of detecting a line gradient outlier with an outlier detection filter such as a Hampel filter.

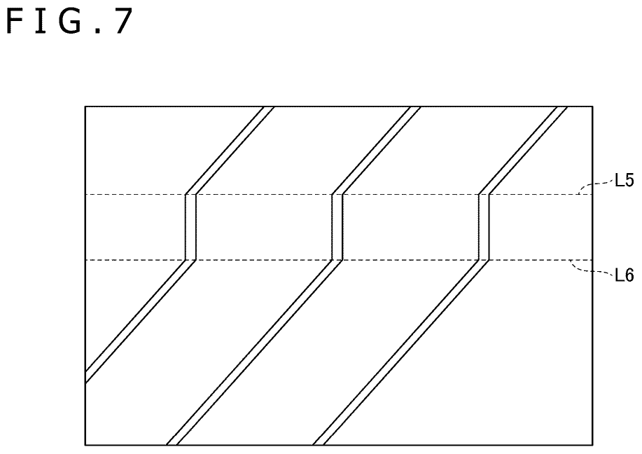

FIG. 7 schematically depicts an example of discontinuous lines that appear in the digest image S if lagging occurs in the target video M, as explained above. This drawing is a partial enlarged view of lines detected by binarization of the digest image S. A plurality of lines extend in a direction intersecting the boundaries (here, a horizontal line) between the partial pictures P and in parallel with each other. Here, it is assumed that lagging occurs during a time period from a time t5 to a time t6. A boundary L5 between the partial pictures P corresponding to the time t5 and a boundary L6 between the partial pictures P corresponding to the time t6 are indicated respectively by broken lines. A plurality of lines that appear in the digest image S due to a temporal change of an object are bent to the same direction at a position in the digest image S corresponding to the timing of occurrence of the lagging. In a case where the plurality of lines is deformed in the same manner, there is a possibility that lagging occurs in the target video M.

It is to be noted that the verification process in this example may be executed on the entirety of the digest image S, or the digest image S may be divided into a plurality of regions, and the verification process may be executed on each of these regions separately. Specifically, as explained above, in a point where a scene transition occurs, it is expected that a line extending in a direction intersecting a boundary does not continue beyond the boundary. Therefore, in a case where the continuity of a line appearing in the digest image S is used to detect the presence/absence of lagging, a line that intersects the boundary representing the scene transition may be difficult to be correctly evaluated. Therefore, the digest image S is divided at the boundaries representing the scene transitions, and a process of detecting the presence/absence of lagging which has been previously explained, is executed on each of the divided regions. Accordingly, verifications can be separately conducted for respective scenes.

Specifically, with regard to the digest image S depicted in FIG. 4, the digest image S is divided at the positions of the straight lines L1 and L2, and each of the three obtained division images is subjected to the foregoing process of detecting a line. Accordingly, the presence/absence of lagging can be detected in each scene.

As a third example, an example of detecting freezing that occurs when the target video M is being displayed will be explained. In a case where freezing occurs when the target video M is being displayed, a state in which the displayed contents are unchanged continues for a certain time period. In this case, a region in the digest image S formed of the partial picture P corresponding to the time period during which the freezing occurs includes the same contents as those in the frozen frame picture F. In addition, similarly to the case of occurrence of lagging, there is a possibility that a discontinuous change occurs at a timing of release of the freezing. Therefore, the verification section 23 detects a change in lines in the digest image S. Accordingly, the verification section 23 can verify a possibility of occurrence of freezing in the target video M.

In addition, in a case where freezing occurs, a screen transition similar to the abovementioned scene transition may be generated at a timing of release of the freezing. Therefore, the detection section 23 executes the process of detecting a line extending along a boundary between the partial pictures P, and, if detecting a line at a position deviated from the expected position or detecting an unexpected line, can determine that there is a possibility of occurrence of freezing.

The verification section 23 may execute the abovementioned verification processes in combination. By way of example, the verification section 23 first verifies the presence/absence of flicker by executing the process of detecting a line extending along a boundary between the partial pictures P, and then, divides the digest image S into a plurality of regions based on the lines detected by this process. Subsequently, the verification section 23 verifies the presence/absence of lagging in the target video M by detection of a discontinuous line in each of the divided regions. Further, the presence/absence of a freezing time period in each of the plurality of regions may be verified simultaneously.

The foregoing explanation describes an example regarding a verification of the target video M using only one digest image S. However, the verification section 23 may create a plurality of the digest images S from one target video M, and may execute a verification process on each of the digest images S. For example, in the foregoing explanation, the size of the digest image S is the same size as the frame pictures F constituting the target video M. Therefore, the number of the partial pictures P that can be included in the digest image S is restrained by the size of the frame pictures F. For this reason, the number of the frame pictures F constituting the target video M for which the digest image S is to be created also depends on the size of the frame pictures F. In a case where a verification process is executed for the target video M including the frame pictures F that are more than the partial pictures P included in one digest image S, the digest image creation section 22 divides a reproduction time of the target video M into multiple periods, and creates the digest image S for each of the divided periods. The verification section 23 executes the abovementioned verification process on each of the digest images S thus created, so that the entire target video M can be verified.

In a specific example, in a case where the target video M is a 60-fps video having a vertical size of 720 pixels, 720 frame pictures F for 12 seconds can form one digest image S. Therefore, it is assumed that, in a case where the target video M is a 60-seconds video, the digest image creation section 22 creates the first digest image S for a time period from 0 to 12 seconds, the second digest image S for a time period from 12 to 24 seconds, and so on, and finally creates five digest images S for respective time periods that do not overlap each other in the total reproduction time of the target video M. On the five digest images S, the verification section 23 executes the verification process of detecting display abnormalities or the like. Accordingly, the target video M having a reproduction time of 60 seconds can be entirely subjected to the verification processes.

However, when the digest images S are separately created for the respective time periods that do not overlap each other in this manner, there is a possibility that a display abnormality etc. that occur over the different time periods cannot be detected. In the foregoing example, if an image lagging occurs around a timing at which 12 seconds have elapsed after start of the reproduction, the partial picture P at the lowest position is extracted from the frame picture F immediately before this timing and is disposed at the lowest position in the first digest image S while the partial picture P at the top position is extracted from the next frame picture F and is disposed on the top in the second digest image S. As a result, a discontinuous line resulting from the lagging appears in neither the first digest image S nor the second digest image S. Accordingly, it can be difficult to detect the lagging.

To this end, the digest image creation section 22 may create the digest images S for time periods that overlap each other. In one example, the digest image creation section 22 may create the digest images S respectively starting from timings of every 6 seconds after the abovementioned reproduction start time point of the target video M, using the 12-seconds frame pictures F. In this case, from the 60-seconds target video M, nine digest images S starting from timings after 0 second, 6 seconds, 12 seconds, 18 seconds, . . . and 48 seconds are created. When these digest images S are set as verification targets, also with regard to any timing in the target video M having a reproduction time period of 60 seconds, the partial pictures P extracted from the frame pictures F before and after the timing can be arranged side by side in any one of the digest images S. It is to be noted that a half of the time period for one digest image S overlaps another digest image S in the foregoing example, but a longer time period may overlap with another digest image S. In this case, more digest images S are created.

In addition, the verification section 23 may verify the target video M by comparing a newly created digest image S with another digest image S previously prepared. Hereinafter, the other digest image S previously prepared is referred to as comparison digest image C in this example. By way of example, a specific program is executed under a certain execution environment, a video (referred to as a comparison video herein) displayed on the screen of the display apparatus 14 is recorded while a specific operation input is performed, and then a digest image S is created on the basis of the recorded video. The digest image S thus created is used as the comparison digest image C. Here, it is assumed to be confirmed that the comparison video used to create the comparison digest image C has been normally displayed.

Thereafter, the target video acquisition section 21 executes the same program as that when the comparison video has been displayed, under an execution environment different from the environment under which the comparison video has been displayed, and records a video displayed on the screen of the display apparatus 14 while performing the same operation input. This video is the target video M to be verified. Here, the different execution environment may be an environment that is different in hardware such as the type of the connected display apparatus 14 from the environment under which the comparison video has been created, or may be an environment that is different in software such as the version of an operating system from the environment under which the comparison video has been created, for example. In this case, in spite of the difference in the execution environments, the displayed contents of the target video M are expected to be similar to those of the comparison video. However, there is a possibility that the difference in the execution environments leads to the difference in the displayed contents, such as occurrence of display lagging, between the target video M and the comparison video.

To this end, the verification section 23 compares the digest image S created from the target video M with the comparison digest image C and determines whether or not a difference is generated in the displayed matters. By way of example, the verification section 23 evaluates a similarity between the entire images by a known technique, and conducts a verification to, if the similarity is below a prescribed value, determine that the displayed contents of the target video M are not as expected. In addition, to detect an abnormality in the displayed contents included in the target video M, the abovementioned process of detecting lines included in the digest image S may be executed, and the number, positions, and directions of the detected lines may be compared with those of lines detected from the comparison digest image C.

In the foregoing explanation, each partial picture P is one pixel row extending in a horizontal direction, and the digest image S is assumed to be a still picture in which the partial pictures P are arranged in a vertical direction and has the same size as the original frame pictures F. However, the sizes and shapes of the digest image S and the partial pictures P constituting the digest image S are not limited to those mentioned above, and any size and shape can be adopted therefor.

Specifically, one partial picture P includes one row of pixels arranged along a horizontal direction in the above explanation, but each partial picture P may be a region including n (n is an integer of 1 or more) pixel rows. Furthermore, each partial picture P may be a picture of a region including one or more pixel rows extending not in a horizontal direction but in a vertical direction. In this case, the boundary between the partial pictures P is a straight line extending in a vertical direction. Alternatively, the partial picture P may be a pixel row extending in a diagonal direction.

For example, in a case where the target video M is a game video to be scrolled vertically, an object and a background of the target video M change mainly in a vertical direction. This change is difficult to be expressed in the digest image S constituting of the partial pictures P extending in a horizontal direction, and is considered to be more clearly expressed in the digest image S if the digest image S is formed by arranging the vertically extending partial pictures P in a horizontal direction. Therefore, the digest image creation section 22 may select the shape and direction of the partial pictures P according to which direction a change of an object or a background occurs in the target video M. In general, when the partial pictures P are arranged so as to be side by side along a direction intersecting the direction of a screen change, the screen change can be easily verified using the digest image S.

In addition, the digest image creation section 22 may create a plurality of the digest images S that are different in arrangement directions from each other, and the verification section 23 may execute a verification process on each of the digest images S. Accordingly, changes in many different directions can be verified.

In addition, the partial pictures P do not necessarily have the same size and the same shape. By way of example, the digest image S may be formed by arranging the partial pictures P having different diameters concentrically.

Furthermore, the digest image creation section 22 may create the digest image S for a partial region of the target video M. For example, in a case where a region for displaying a parameter or the like of a game character is disposed along the upper side of the target video M, a sudden temporal change is unlikely to occur in this region where an object does not move. Therefore, the remaining region may be set as an attention region, and the partial pictures P may be extracted from the attention region to create the digest image S. In addition, in a case where a relatively large change is expected to occur in a region near the center portion of the screen in the target video M, a region excluding the outer periphery may be set as an attention region, and then, the digest image S may be created therefor. In this example, the size of the created digest image S is not the same as the size of the frame pictures F constituting the target video M, and the size and shape of the digest image S are the same as the size and shape of the attention region.

The attention region is not required to be rectangle and may have any shape such as a trapezoidal shape. Further in this case, the digest image creation section 22 may alter the shape of the partial picture P extracted from the attention region in each frame picture F by, for example, affine transformation to create the digest image S. Accordingly, the partial pictures P each extracted from an attention region having a trapezoidal shape or the like may be combined so that the digest image S of a rectangular shape can be created.

As explained so far, the digest image S is created for an attention region having a given shape at a given position in the target video M, whereby the digest image S that expresses a temporal change in a region to receive more attention can be created. In particular, a region within which an important object can move or a region to be expected to receive a user's attention is defined as an attention region so that a display trouble occurring in the region can be easily detected. It is to be noted that, also in this example, the partial pictures P extracted from the temporally adjacent frame pictures F are arranged to be spatially adjacent to each other in the digest image S so that the verification section 23 can execute the verification process of, for example, detecting a scene transition by using the digest image S.

In addition, the digest image creation section 22 may create the respective digest images S for different attention regions. For example, the digest image S for the upper half part of the target video M and the digest image S for the lower half part may be separately created. It is considered that, if the verification section 23 executes the verification process on each of the created digest images S, a display abnormality occurring within a local range is likely to be detected.

In addition, by using a technology such as NeRF (Neural Radiance Fields) which is used to create a free viewpoint image in a three-dimensional space, the digest image creation section 22 may determine the shape and size of an attention region from which the partial pictures P are extracted, and determine how to transform the partial pictures P and arrange the partial pictures P in the digest image S. If a plurality of the frame pictures F formed in two-dimensional planes are arranged in parallel in the depth direction, a three-dimensional space of coordinate axes (x, y, and t) can be formed. In this space, x and y respectively indicate the coordinate axes in a horizontal direction and a vertical direction of each frame picture F while t indicates a time axis. The digest image S corresponds to an image obtained by projecting such a three-dimensional space onto a given projection plane. Therefore, the digest image creation section 22 may decide how to set the projection plane using a technology of rendering a state in a three-dimensional space. Accordingly, the digest image S in which movement of an object in the target video M is more clearly expressed can be created.

As explained so far, by analyzing the digest image S, the image processing apparatus 10 according to the present embodiment can relatively efficiently verify the contents of the target video M.

It is to be noted that the embodiment of the present invention is not limited to those explained above. By way of example, the shapes and sizes of the partial pictures P extracted from the respective frame pictures F are the same in the foregoing explanation, but the sizes of the partial pictures P may vary. For example, in a part for a time period including a drastic screen change in the target video M, the digest image creation section 23 sets the width of the partial pictures P (that is, the size in the direction in which the partial pictures P are arranged) to be small, and, in a part for a time period including a relatively small screen change, the digest image creation section 23 sets the width of the partial pictures P to be large. Accordingly, the digest image S can be created in which, in a part for a time period including a drastic change, the change is more elaborately reflected.

In the foregoing explanation, the position of the partial picture P extracted from one frame picture F is determined so as not to overlap the positions of the partial pictures P extracted from the other frame pictures F. The present invention is not limited to this, and each partial picture P may be arranged so as to partially overlap the adjacent partial picture P in the digest image S. By way of example, in a case where each partial picture P includes three pixel rows extending in a horizontal direction and arranged in a vertical direction, the digest image creation section 22 may arrange the partial pictures P in such a way that the top one of the three pixel rows overlaps the lowest pixel row of the partial picture P extracted from the preceding frame picture F and the lowest pixel row overlaps the top pixel row of the partial picture P extracted from the following frame picture F. In this case, in a position where two adjacent partial pictures P overlap, these adjacent partial pictures P are made translucent and superimposed, for example. Accordingly, the digest image S in which a smoother change is expressed can be created.

### Reference Signs List

10: Image processing apparatus
11: Control section
12: Storage section
13: Interface section
14: Display apparatus
15: Operation device
21: Target video acquisition section
22: Digest image creation section
23: Verification section

What is claimed is:

1. An image processing apparatus comprising:
one or more processors, wherein
the one or more processors
creates at least one digest image by extracting, from each of a plurality of frame pictures constituting a video to be verified, partial pictures of positions different from each other, and
verifies contents of the video on a basis of the digest image.

2. The image processing apparatus according to claim 1, wherein
the one or more processors
detects a display abnormality included in the video on the basis of the digest image.

3. The image processing apparatus according to claim 2, wherein
the one or more processors
detects a line included in the digest image, and detects a display abnormality included in the video on a basis of the detected line.

4. The image processing apparatus according to claim 3, wherein
the one or more processors
detects a display abnormality included in the video by detecting a line that extends along a boundary between the partial pictures.

5. The image processing apparatus according to claim 3, wherein
the one or more processors
detects a display abnormality included in the video by detecting a line that extends in a direction intersecting a boundary between the partial pictures and that has a discontinuous section.

6. The image processing apparatus according to claim 3, wherein
the one or more processors
divides the digest image into a plurality of regions on a basis of a line extending in a direction along a boundary between the partial pictures, and verifies, for each of the plurality of regions, the contents of the video of a time period corresponding to the region.

7. The image processing apparatus according to claim 1, wherein
the one or more processors
identifies a time period of the video during which no display change occurs, by detecting a region that includes continuous contents along a direction intersecting a boundary between the partial pictures in the digest image.

8. The image processing apparatus according to claim 1, wherein
the one or more processors
verifies the contents of the video by comparing the digest image with a given comparison image.

9. The image processing apparatus according to claim 1, wherein
the one or more processors
determines an attention region in the video, extracts, as the partial picture, an image of a portion of the attention region included in each of the plurality of frame pictures, and creates the digest image.

10. The image processing apparatus according to claim 1, wherein
the one or more processors
executes prescribed affine transformation on the partial pictures extracted from each of the plurality of frame pictures, and then combines resultant partial pictures to create the digest image.

11. The image processing apparatus according to claim 1, wherein
the one or more processors
creates a plurality of digest images starting from a plurality of time points different from each other in the video on a basis of frame pictures to be displayed after the starting points, and
verifies the contents of the video on a basis of the plurality of digest images.

12. An image processing method comprising:
creating at least one digest image by extracting, from each of a plurality of frame pictures constituting a video to be verified, partial pictures of positions different from each other; and
verifying contents of the video on a basis of the digest image.

13. A program for causing a computer to execute processes of:
creating at least one digest image by extracting, from each of a plurality of frame pictures constituting a video to be verified, partial pictures of positions different from each other; and
verifying contents of the video on a basis of the digest image.
